(19) United States
(12) Patent Application Publication
(10) Pub. No.: US 2019/0233621 A1
(43) Pub. Date: Aug. 1, 2019

(54) BASE TREAD RUBBER MEMBER AND PNEUMATIC TIRE USING SAME

(71) Applicant: Toyo Tire Corporation, Itami-shi, Hyogo (JP)

(72) Inventor: Hiroyuki Takahashi, Itami-shi (JP)

(73) Assignee: Toyo Tire Corporation, Itami-shi, Hyogo (JP)

(21) Appl. No.: 16/331,707

(22) PCT Filed: Sep. 7, 2017
(86) PCT No.: PCT/JP2017/032217

§ 371 Date: Mar. 8, 2019

(30) Foreign Application Priority Data
Oct. 14, 2016 (JP) 2016-202903

(51) Int. Cl. C08L 7/00; C08K 5/20; C08K 3/04; C08K 3/36; B60C 1/00; B60C 11/00

(52) U.S. Cl. CPC C08L 7/00; C08K 5/20; C08K 3/04; C08K 2201/006; B60C 1/0016; B60C 11/0008; C08K 3/36

(57) ABSTRACT

Provided are a base tread rubber member that can improve low heat generation properties while maintaining tear resistance and a pneumatic tire using the same.

A base tread rubber member comprising a rubber composition containing 100 parts by mass of a diene rubber, 10 to 70 parts by mass of carbon black having a nitrogen adsorption specific surface area of 20 to 80 m²/g, 1 to 10 parts by mass of silica having a nitrogen adsorption specific surface area of 80 to 200 m²/g and 0.1 to 10 parts by mass of a compound represented by the formula (I) (in the formula (I), R¹ and R² represent a hydrogen atom, an alkyl group, an alkenyl group or an alkynyl group, and M⁺ is Na⁺, K⁺ or Li⁺).

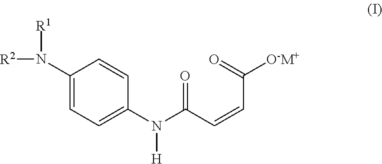

### TECHNICAL FIELD

The present invention relates to a base tread rubber member and pneumatic tire using the same.

### TECHNICAL BACKGROUND

In recent years, demand for low heat generation properties to automobiles is increasing and a rubber member having excellent low heat generation properties is desired to be provided.

Carbon black is widely used as filler for a rubber composition for a tire in that reinforcing properties and abrasion resistance are good. In case where low heat generation properties of the composition comprising carbon black are improved, a method of using carbon black having large particle diameter and a method of decreasing the amount of carbon black are considered.

It is known to add (2Z)-4-[(4-aminophenyl)amino]-4-oxo-2-butenoic acid salt as an amine compound in order to improve low heat generation properties of a rubber composition (see Patent Documents 1 to 3).

### PRIOR ART DOCUMENTS

### Patent Document

Patent Document 1: JP-A-2014-95013

Patent Document 2: JP-A-2014-95015

Patent Document 3: JP-A-2014-95018

### SUMMARY OF THE INVENTION

### Problems that the Invention is to Solve

However, when the carbon black having large panicle diameter and the amine compound were used together, there was a problem that tear resistance is deteriorated.

In view of the above, the present invention has an object to provide a base tread rubber member that can improve low heat generation properties while maintaining tear resistance and a pneumatic tire using the same.

### Means for Solving the Problems

The base tread rubber member according to the present invention comprises a rubber composition containing 100 parts by mass of a diene rubber, 10 to 70 parts by mass of carbon black having a nitrogen adsorption specific sin face area of 20 to 80 m²/g, 1 to 10 parts by mass of silica having a nitrogen adsorption specific surface area of 80 to 200 m²/g and 0.1 to 10 parts by mass of a compound represented by the following formula (I).

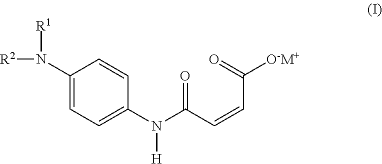

In the formula (I), R¹ and R² represent a hydrogen atom, an alkyl group having 1 to 20 carbon atoms, an alkenyl group having 1 to 20 carbon atoms or an alkynyl group having 1 to 20 carbon atoms, and R¹ and R² may be the same or different. M⁺ represents a sodium ion, a potassium ion or a lithium ion.

The pneumatic tire according to the present invention is manufactured using the base tread rubber member.

### Effects of the Invention

According to the present invention, low heat generation properties can be improved while maintaining and/or improving tear resistance.

### MODE FOR CARRYING OUT THE INVENTION

Items relating to the embodiment of the present invention are described in detail below.

The base tread rubber member according to this embodiment comprises a rubber composition containing 100 parts by mass of a diene rubber, 10 to 70 parts by mass of carbon black having a nitrogen adsorption specific surface area of 20 to 80 m²/g, 1 to 10 parts by mass of silica having a nitrogen adsorption specific surface area of 80 to 200 m²/g and 0.1 to 10 parts by mass of the compound represented by the formula (I).

In the rubber composition according to this embodiment, examples of the diene rubber used as a rubber component include natural rubber (NR), isoprene rubber (IR), butadiene rubber (BR), styrene-butadiene rubber (SBR), styrene-isoprene copolymer rubber, butadiene-isoprene copolymer rubber and styrene-isoprene-butadiene copolymer rubber. Those diene rubbers can be used in one kind alone or as blends of two or more kinds. The rubber component is preferably natural rubber, butadiene rubber, styrene-butadiene rubber or blends of two or more kinds of those.

A blend rubber of natural rubber and other diene rubber is preferably used as the diene rubber, and a blend rubber of natural rubber (NR) and butadiene lubber (BR) is particularly preferably used.

The content ratio of natural rubber in the diene rubber is not particularly limited, but is preferably 30 to 100 mass % and more preferably 50 to 90 mass %.

When the diene rubber is a blend rubber of natural rubber (NR) and butadiene rubber (BR), the ratio of those is not particularly limited, but the NR/BR ratio is preferably 30/70 to 100/0 and more preferably 50/50 to 90/10, in mass ratio.

The butadiene rubber (that is, polybutadiene rubber) is not particularly limited, and examples thereof include (A1) a high cis-butadiene rubber. (A2) a syndiotactic crystal-containing butadiene rubber and (A3) a modified butadiene rubber. Those rubbers can be used in any one kind or as mixtures of two or more kinds.

The high cis-BR (A1) includes a butadiene rubber having a cis content (that is, cis-1.4 bond content) of 90 mass % or more (preferably 95 mass % or more), and specific examples thereof include a cobalt type butadiene rubber polymerized using a cobalt catalyst, a nickel type butadiene rubber polymerized using a nickel catalyst and a rare earth type butadiene rubber polymerized using a rare earth metal catalyst. The rare earth type butadiene rubber is preferably a neodymium type butadiene rubber polymerized using a neodymium catalyst, and the neodymium type butadiene rubber having a cis content of 96 mass % or more and a vinyl content (that is, 1,2-vinyl bond content) of less than 1.0 mass % (preferably 0.8 mass % or less) is preferably used. The use of the rare earth type butadiene rubber is advantageous to the improvement of low heat generation properties. The cis content and vinyl content are values calculated by an integration ratio of ¹N-NMR spectrum Specific example of the cobalt type BR includes “UBEPOL BR” manufactured by Ube Industries, Ltd. Specific examples of the neodymium type BR include “BUNA CA22” and “BUNA CA25” manufactured by LAXESS.

Butadiene rubber that is a rubber resin composite comprising high cis-butadiene rubber as a matrix and syndiotactic 1,2-polybutadiene crystals (SPB) dispersed therein is used as the syndiotactic crystal-containing butadiene rubber (SPB-containing BR) (A2). The use of the SPB-containing BR is advantageous to the improvement of hardness. The SPB content in the SPB-containing BR is not particularly limited, and for example, may be 2.5 to 30 mass % and may be 10 to 20 mass %. The SPB content in the SPB-containing BR is obtained by measuring a boiling n-hexane insoluble content. Specific example of the SPB-containing BR includes “UBEPOL VCR” manufactured by Ube Industries, Ltd.

Examples of the modified BR (A3) include an amine-modified BR and a tin-modified. BR. The use of the modified BR is advantageous to the improvement of low heat generation properties. The modified BR may be an end-modified BR having a functional group introduced in at least one end of a molecular chain of BR, may be a main chain-modified BR having a functional group introduced in the main chain and may be a main chain and end-modified BR having functional groups introduced in the main chain and the end. Specific example of the modified BR includes “BR 1250H” (amine end-modified BR) manufactured by Zeon Corporation.

In one embodiment, when the high cis-BR (A1) and the SPB-containing BR (A2) are used together, 100 parts by mass of the diene rubber may contain 40 to 70 parts by mass NR and/or IR, 20 to 40 parts by mass of high cis-BR and 10 to 30 parts by mass of SPB-containing BR. When the high cis-BR (A1) and the modified BR (A3) are used together, 100 parts by mass of the diene rubber may contain 40 to 70 parts by mass of NR and/or IR, 20 to 40 parts by mass of high cis-BR and 10 to 30 parts by mass of modified BR. When the cobalt type BR and the neodymium type BR are used together as the high cis-BR (A1), 100 parts by mass of the diene rubber may contain 40 to 70 parts by mass of NR and/or IR, 20 to 40 parts by mass of cobalt type BR and 10 to 30 parts by mass of neodymium type BR.

The rubber composition according to this embodiment uses carbon black and silica as reinforcing fillers.

The carbon black is not particularly limited so long as a nitrogen adsorption specific surface area (N₂SA) measured according to JIS K6217-2 is 20 to 80 m/g. The nitrogen adsorption specific surface area is preferably 25 to 70 m²/g, more preferably 25 to 60 m²/g and particularly preferably 35 to 50 m²/g. Specific examples of the carbon black include carbon blacks of GPF grade and FEF grade. When the nitrogen adsorption specific surface area is 20 m²/g or more, the rubber composition has excellent reinforcing properties. When the carbon black having the nitrogen adsorption specific surface area of larger than 80 m²/g is used, large deterioration of tear resistance by the co-use with the compound represented by the formula (I) is not recognized.

The carbon black content is 10 to 70 parts by mass per 100 parts by mass of the diene rubber, and the content is preferably 10 to 50 parts by mass and more preferably 20 to 50 parts by mass, from the standpoint of both low heat generation properties and tear resistance. When the carbon black content is 10 parts by mass or more, the rubber composition has excellent reinforcing properties, and when the carbon black content is 70 parts by mass or less, the rubber composition has excellent low heat generation properties.

The silica is not particularly limited so long as a nitrogen adsorption specific surface area (BET) measured according to BET method defined in JIS K6430 is 80 to 200 m²/g. The nitrogen adsorption specific surface area is preferably 100 to 200 m²/g, more preferably 110 to 190 m²/g and particularly preferably 130 to 190 m²/g. Wet silica such as wet precipitated silica or wet gelled silica is preferably used. When the nitrogen adsorption specific surface area is 200 m²/g 01 less, the improvement effect of tear resistance when the silica is used together with the compound represented by the formula (I) is excellent.

The silica content is 1 to 10 parts by mass per 100 parts by mass of the diene rubber. The content is preferably 3 to 10 parts by mass from the standpoint of both low heat generation properties and tear resistance.

The content of the reinforcing filler (the total amount of carbon black and silica) is not particularly limited, and is preferably 10 to 80 parts by mass more preferably 20 to 50 parts by mass and still more preferably 30 to 50 parts by mass, per 100 parts by mass of the diene rubber.

When containing silica, a silane coupling agent such as sulfide slime or mercaptosilane may further be contained, but the silane coupling agent is not preferably contained. When containing the silane coupling agent, the content thereof is preferably 2 to 20 mass % based on the silica content.

The compound represented by the following formula (I) is used in the rubber composition according to this embodiment.

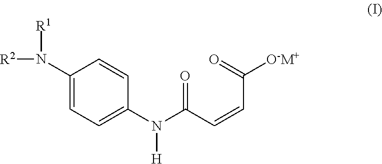

In the formula (I), R¹ and R² represent a hydrogen atom, an alkyl group having 1 to 2.0 carbon atoms, an alkenyl group having 1 to 20 carbon atoms or an alkynyl group having 1 to 20 carbon atoms, and R¹ and R² may be the same or different.

Examples of the alkyl group in R and R′ include methyl group, ethyl group, n-propyl group, isopropyl group, n-butyl group, sec-butyl group and tert-butyl group. Examples of the alkenyl group in R¹ and R² include vinyl group, group 1-propenyl group and 1-methylethenyl group. Examples of the alkynyl group in R¹ and R² include ethynyl group and propargyl group. Those alkyl group, alkenyl group and alkynyl group have the number of carbon atoms of preferably 1 to 10 and more preferably 1 to 5. R¹ and R² are preferably a hydrogen atom or an alkyl group having 1 to 5 carbon atoms, more preferably a hydrogen atom or methyl group and still more preferably a hydrogen atom. In one embodiment, —NR¹R² in the formula. (I) is preferably —NH₂, —NHCH₃ or —N(CH₃)₂ and more preferably —NH₂.

M⁺ in the formula (I) is a sodium ion, a potassium ion or a lithium ion and is preferably a sodium ion.

The content of the compound represented by the formula (I) is 0.1 to 10 parts by mass per 100 parts by mass of the diene rubber, and is preferably 0.5 to 8 parts by mass and more preferably 1 to 5 parts by mass, from the standpoint of low heat generation properties. When the content is 0.1 parts by mass or more, the improvement effect of low heat generation properties is excellent, and when the content is 10 parts by, mass or less, deterioration of tear resistance can be suppressed.

The improvement effect of low heat generation properties is recognized by containing the compound represented by the formula (I). The mechanism is not clear, but it is considered as follows.

It is assumed that terminal amine of the compound of the formula (I) is reacted with a functional group on the surface of carbon black and carbon-carbon double bond portion located between an amide group and carboxylic acid salt in the compound of the formula (I) is bonded to a polymer, thereby dispersibility of the carbon black car improved and this contributes to low heat generation properties.

On the other hand, when carbon black having large particle diameter and the compound of the formula (I) are used together, there was the case that the reaction between the compound of the formula (I) and a part of the carbon black is accelerated, and tear resistance is deteriorated. In contrast, heat generation properties could be improved while maintaining tear resistance by further containing silica having a nitrogen adsorption specific surface area in a predetermined range. The mechanism is not clear, but it is assumed that the reaction between the carbon black and the compound of the formula (I) is appropriately relaxed by that the silica adsorbs the compound of the formula (I), the silica itself contributes to the improvement of tear resistance, and as a result, low heat generation properties can be improved while maintaining tear resistance.

The rubber composition according to this embodiment can appropriately contain compounding ingredients generally used in rubber industries, such as a process oil, zinc flower, stearic acid, a softener, a plasticizer, wax, an age resister, a vulcanizing agent and a vulcanization accelerator, in general amounts, in addition to the above-described each component.

Examples of the vulcanizing agent include sulfur components such as powdered sulfur, precipitated sulfur, colloidal sulfur, insoluble sulfur and highly dispersible sulfur. Although not particularly limited, the content of the vulcanizing agent is preferably 0.1 to 10 parts by mass and more preferably 0.5 to 5 parts by mass, per 100 parts by mass of the diene rubber. The content of the vulcanization accelerator is preferably 0.1 to 7 parts by mass and more preferably 0.5 to 5 parts by mass, per 100 parts by mass of the diene rubber.

The rubber composition according to this embodiment can be prepared by kneading the necessary components according to the conventional method using a mixing machine generally used, such as Banbury mixer, a kneader or rolls. Specifically, other additives excluding a vulcanizing agent and a vulcanization accelerator are added to the rubber component together with a reinforcing filler and the compound of the formula (I), followed by mixing, in a first mixing step. A vulcanizing agent and a vulcanization accelerator are then added to the mixture thus obtained, followed by mixing, in a final mixing step. Thus, a rubber composition can be prepared.

The rubber composition thus obtained can be formed into a rubber member used in a tread rubber constituting a ground-contact surface of a tire, and is particularly used as a base tread rubber member of a tread rubber comprising a two-layered structure of a cap rubber and a base tread rubber. For example, the rubber composition is extrusion-molded into a predetermined cross-sectional shape corresponding to a base tread part. Alternatively, a ribbon-shaped rubber strip comprising the rubber composition is spirally wound on a drum to form a cross-sectional shape corresponding to a base tread part. Thus, an vulcanized base tread rubber member is obtained. The base tread rubber member is fabricated into a tire shape together with other tire members constituting a tire, such as an inner liner, a carcass, a belt, a bead core, a bead filler and a sidewall, according to the conventional method. Thus, a green tire (unvulcanized tire) is obtained. The green tire thus obtained is vulcanization-molded at, for example, 140 to 180° C.′ according to the conventional method. Thus, a pneumatic tire having a base tread part comprising the base tread rubber member is obtained.

The kind of the pneumatic tire according to this embodiment is not particularly limited, and examples of the pneumatic tire include various tires such as tires for passenger cars and heavy load tires used in trucks, buses and the like.

### EXAMPLES

Examples of the present invention are described below, but the present invention is not construed as being limited to those examples.

Banbury mixer was used. Components excluding a vulcanization accelerator and sulfur were added to a diene rubber according to the formulations (parts by mass) shown in Table 1 below, followed by mixing, in a first mixing step (non-processing kneading process) (discharge temperature: 160° C.). A vulcanization accelerator and sulfur were added to the mixture obtained, followed by kneading, in a final mixing step (processing kneading process) (discharge temperature: 90° C.). Thus, a rubber composition used as a base tread rubber member was prepared.

The details of each component in Table 1 are as follows.

NR: RSS#3

BR: Butadiene rubber, “BR150” manufactured by Ube Industries, Ltd.

Carbon black 1: FEF grade, “SEAST SO” (N₂SA=42 m²/g) manufactured by Tokai Carbon Co., Ltd.

Carbon black 2: GPF grade, “SEAST V” (N₂SA=27 m²/g) manufactured by Tokai Carbon Co., Ltd.

Carbon black 3: HAF grade, “SEAST KH” (N₂SA=90 m²/g) manufactured by Tokai Carbon Co., Ltd.

Silica 1: “9100GR” (BET=235 m²/g) manufactured by Evonik

Silica 2: “VN3” (BET=180 m²/g) manufactured by Evonik

Silica 3: “1115MP” (BET=115 m²/g) manufactured by Rhodia

Compound (I): (2Z)-4-[(4-aminophenyl)amino]-4-oxo-2-butenoic acid sodium salt (compound represented by the following formula (I′)) manufactured by Sumitomo Chemical Co., Ltd.

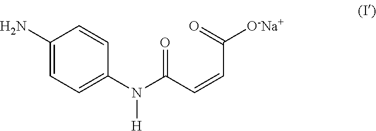

Zinc flower: “Zinc Flower #1” manufactured by Mitsui Mining & Smelting Co., Ltd.

Wax: “OZOACE 0355” manufactured by Nippon Seiro Co., Ltd.

Stearic acid: “Industrial Stearic Acid” manufactured by Kao Corporation

Sulfur: “5% Oil-Treated Powdered Sulfur” manufactured by Tsurumi Chemical Industry Co., Ltd.

Vulcanization accelerator: “NOCCELER NS-P” manufactured by Ouchi Shinko Chemical Industrial Co., Ltd.

Tear resistance and low heat generation properties of each rubber composition obtained were evaluated. The evaluation methods are as follows.

Tear resistance: Measured according to JIS K6252. Specifically, using a sample obtained by punching into a specified crescent shape and making a cut of 0.5±0.08 Min in the center of depression, a test is conducted in a tensile rate of 500 min/min by a tensile tester manufactured by Shimadzu Corporation. The maximum value of tearing force until a test piece breaks is read. The results of Examples 1 to 4 and Comparative Examples 2 to 5 were indicated by an index as the result of Comparative Example 1 being 100, the result of Example 1-2 was indicated by an index as the result of Comparative Example 1-2 being 100, the result of Example 1-3 was indicated by an index as the result of Comparative Example 1-3 being 100 and the result of Reference Example 2 was indicated by an index as the result of Reference Example 1 being 100. When the value is 90 or more, it shows that tear resistance is excellent.

Low heat generation properties: Measured according to HS K6394. Specifically, loss factor tan δ of a test piece vulcanized at 150° C. for 30 minutes was measured under the conditions of temperature: 60° C., static strain: 10%, dynamic strain: 1% and frequency: 10 Hz using a viscoelasticity testing machine manufactured by Toro Seiki Seisaku-Sho. The results of Examples 1 to 4 and Comparative Examples 2 to 5 were indicated by an index as the result of Comparative Example 1 being 100, the result of Example 1-2 was indicated by an index as the result of Comparative Example 1-2 being 100, the result of Example 1-3 was indicated by an index as the result of Comparative Example 1-3 being 100, and the result of Reference Example 2 was indicated by an index as the result of Reference Example 1 being 100. When the index is 98 or less, it shows that tan δ is small and low heat generation properties are excellent.

TABLE 1

| | | | | | | | | | | Com. | | Com. | | | |
|---|---|---|---|---|---|---|---|---|---|---|---|---|---|---|---|
| | Com. | Com. | Com. | | | | Com. | | Com. | Ex. | Ex. | Ex. | Ex. | Ref. | Ref. |
| | Ex. 1 | Ex. 2 | Ex. 3 | Ex. 1 | Ex. 2 | Ex. 3 | Ex. 4 | Ex. 4 | Ex. 5 | 1-2 | 1-2 | 1-3 | 1-3 | Ex. 1 | Ex. 2 |
| Formulation | | | | | | | | | | | | | | | |
| (parts by mass) | | | | | | | | | | | | | | | |
| NR | 70 | 70 | 70 | 70 | 70 | 70 | 70 | 70 | 70 | 70 | 70 | 70 | 70 | 70 | 70 |
| BR | 30 | 30 | 30 | 30 | 30 | 30 | 30 | 30 | 30 | 30 | 30 | 30 | 30 | 30 | 30 |
| Carbon black 1 | 30 | 30 | 30 | 30 | 30 | 30 | 30 | 30 | 30 | 45 | 45 | — | — | — | — |
| Carbon black 2 | — | — | — | — | — | — | — | — | — | — | — | 30 | 30 | — | — |
| Carbon Black 3 | — | — | — | — | — | — | — | — | — | — | — | — | — | 30 | 30 |
| Silica 1 | — | — | — | — | — | — | — | — | 5 | — | — | — | — | — | — |
| Silica 2 | — | — | 5 | 5 | 5 | 8 | 15 | — | — | — | 5 | — | 5 | — | — |
| Silica 3 | — | — | — | — | — | — | — | 5 | — | — | — | — | — | — | — |
| Compound (1) | — | 2 | — | 1 | 2 | 2 | 2 | 2 | 2 | — | 1 | — | 1 | — | 1 |
| Zinc flower | 3 | 3 | 3 | 3 | 3 | 3 | 3 | 3 | 3 | 3 | 3 | 3 | 3 | 3 | 3 |
| Wax | 2 | 2 | 2 | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 | 2 | 2 | 2 |
| Sulfur | 2 | 2 | 2 | 2 | 2 | 2 | 2 | 2 | 2 | 2 | 2 | 2 | 2 | 2 | 2 |
| Vulcanization | 1 | 1 | 1 | 1 | 1 | 1 | 1 | 1 | 1 | 1 | 1 | 1 | 1 | 1 | 1 |
| accelerator | | | | | | | | | | | | | | | |
| Tear resistance | 100 | 77 | 105 | 104 | 102 | 105 | 103 | 94 | 88 | 100 | 103 | 100 | 100 | 100 | 94 |
| Low heat generation | 100 | 94 | 102 | 97 | 96 | 97 | 102 | 95 | 98 | 100 | 98 | 100 | 97 | 100 | 97 |
| properties | | | | | | | | | | | | | | | |

The results are shown in Table 1. It was recognized in all of Examples 1 to 4. Example 1-2 and Example 1-3 that low heat generation properties are improved while maintaining and/or improving tear resistance.

Furthermore, it was recognized from the comparison between Comparative Example 1 and Comparative Example 2 that the improvement effect of low heat generation properties is recognized by the addition of the compound (I), but tear resistance is deteriorated from 100 to 77,

As compared with Comparative Example 2, it was recognized in Example 2 having predetermined silica added thereto that tear resistance is improved from 77 to 102. From the comparison between Comparative Example 1 and Comparative Example 3, this improvement effect was remarkable effect as compared with the improvement effect of tear resistance recognized when predetermined silica was added to the rubber composition.

The deterioration of low heat generation properties was recognized in Comparative Example 4 in which the content of the predetermined silica is larger than 10 parts by mass per 100 parts by mass of the diene rubber.

The deterioration of tear resistance by the addition of the compound (I) could not be compensated in Comparative Example 5 in which silica that does not have a nitrogen adsorption specific surface area of 80 to 200 m²/g was added.

From the comparison between Reference Example 1 and Reference Example 2, when the carbon black having a nitrogen adsorption specific surface area of 90 m²/g and the compound (I) were added to the rubber composition, great deterioration of tear resistance was not recognized.

### INDUSTRIAL APPLICABILITY

The base tread rubber member of the present invention can be used in various tires of passenger cars, light tucks, buses and the like.

1-2. (canceled)

3. A base tread rubber member comprising
a rubber composition containing 100 parts by mass of a diene rubber,
10 to 70 parts by mass of carbon black having a nitrogen adsorption specific surface area of 20 to 80 m²/g,
1 to 10 parts by mass of silica having a nitrogen adsorption specific surface area of 80 to 200 m²/g and
0.1 to 10 parts by mass of a compound represented by the following formula (I) 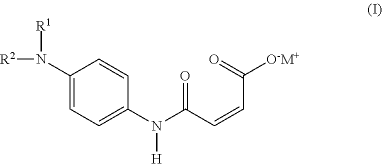
wherein R¹ and R² represent a hydrogen atom, an alkyl group having 1 to 20 carbon atoms, an alkenyl group having 1 to 20 carbon atoms or an alkynyl group having 1 to 20 carbon atoms, R¹ and R² may be the same or different, and M⁺ represents a sodium ion, a potassium ion or a lithium ion.

4. The base tread rubber member according to claim 3, wherein the content of the carbon black having a nitrogen adsorption specific surface area of 20 to 80 m²/g is 10 to 50 parts by mass based on 100 parts by mass of the diene rubber, and the content of reinforcing filler as the total amount of carbon black and silica is 20 to 50 parts by mass based on 100 parts by mass of the diene rubber.

5. The base tread rubber member according to claim 3, wherein the diene rubber comprises a blend rubber of natural rubber (NR) and, a butadiene rubber having a cis-1,4 bond content of 90 mass % or more.

6. The base tread rubber member according to claim 4, wherein the diene rubber comprises a blend rubber of natural rubber (NR) and, a butadiene rubber having a cis-1,4 bond content of 90 mass % or more.

7. A pneumatic tire manufactured using the base tread rubber member according to claim 3.

8. A pneumatic tire manufactured using the base tread rubber member according to claim 4.

9. A pneumatic tire manufactured using the base tread rubber member according to claim 5.

10. A pneumatic tire manufactured using the base tread rubber member according to claim 6.
